(19) United States
(12) Patent Application Publication
(10) Pub. No.: US 2015/0130579 A1
(43) Pub. Date: May 14, 2015

(54) MULTI SPIRAL INDUCTOR

(71) Applicant: Qualcomm Incorporated, San Diego, CA (US)

(72) Inventors: Daeik Daniel Kim, San Diego, CA (US); Jonghae Kim, San Diego, CA (US); Changhan Hobie Yun, San Diego, CA (US); Mario Francisco Velez, San Diego, CA (US); Chengjie Zuo, Santee, CA (US)

(73) Assignee: Qualcomm Incorporated, San Diego, CA (US)

(21) Appl. No.: 14/078,174

(22) Filed: Nov. 12, 2013

(51) Int. Cl. H01F 27/28; H01F 41/06

(52) U.S. Cl. CPC H01F 27/2804; H01F 41/06; H01F 2027/2809
USPC 336/200; 29/602.1

(57) ABSTRACT

An apparatus includes a multi spiral inductor that includes a first spiral and a second spiral. The first spiral includes a first turn, a second turn, and a third turn. The first turn is adjacent to and separated from the second turn by first spacing. The second turn is adjacent to and separated from the third turn by second spacing. The first spacing is different from the second spacing.

### I. FIELD

The present disclosure is generally related to a multi spiral inductor.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Electronic devices, such as wireless telephones, may include inductors for power regulation, frequency control, and/or signal conditioning. One type of inductor is the spiral inductor. Inductors with higher electrical resistance may consume more power than inductors with lower electrical resistance. The quality of a spiral inductor can be indicated by a quality factor (“Q factor”) that is inversely proportional to electrical resistance. Thus, the higher the Q factor of a spiral inductor, the less magnetic loss experienced by the spiral inductor. A multi spiral inductor can be formed from individual spiral inductors.

### III. SUMMARY

Multi spiral inductors (e.g., a stacked double spiral inductor) and methods of forming multi spiral inductors are disclosed. In accordance with the present disclosure, the spacing between the turns of individual spiral inductor(s) in a multi spiral inductor can be varied to improve the Q factor. The technique of varying spacing can also be combined with the technique of varying trace width to improve the Q factor.

In a particular embodiment, an apparatus includes a multi spiral inductor that includes a first spiral and a second spiral. The first spiral includes a first turn, a second turn, and a third turn. The first turn is adjacent to and separated from the second turn by first spacing. The second turn is adjacent to and separated from the third turn by second spacing. The first spacing is different from the second spacing.

In another particular embodiment, a method includes forming a first spiral of a multi spiral inductor. The first spiral includes a first turn, a second turn, and a third turn. The first turn is adjacent to and separated from the second turn by first spacing. The second turn is adjacent to and separated from the third turn by second spacing. The first spacing is different from the second spacing or a first trace width of the first turn is different from a second trace width of the second turn. The method also includes forming a second spiral of the multi spiral inductor.

In another particular embodiment, an apparatus includes a multi spiral inductor that includes first means for storing energy in a magnetic field, second means for storing energy in a magnetic field, and means for connecting the first means for storing and the second means for storing. The first means for storing includes a first turn, a second turn, and a third turn. The first turn is adjacent to and separated from the second turn by first spacing, and the second turn is adjacent to and separated from the third turn by second spacing. The first spacing is different from the second spacing, or a first trace width of the first turn is different from a second trace width of the second turn.

In another particular embodiment, a non-transitory computer-readable medium includes instructions that when executed by a processor, cause the processor to initiate formation of a multi spiral inductor that includes a first spiral and a second spiral. The first spiral includes a first turn, a second turn, and a third turn. The first turn is adjacent to and separated from the second turn by first spacing, and the second turn is adjacent to and separated from the third turn by second spacing. The first spacing is different from the second spacing.

One particular advantage provided by at least one of the disclosed embodiments is a multi spiral inductor that exhibits an increased Q factor. Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a diagram to illustrate a particular embodiment of a multi spiral inductor that includes a spiral having variable turn spacing;

FIG. 2 is a diagram to illustrate a particular embodiment of a multi spiral inductor that includes spirals that are congruent reflections of each other and that include variable turn spacing;

FIG. 3 is a diagram to illustrate a particular embodiment of a multi spiral inductor that includes spirals having variable trace width;

FIG. 4 is a diagram to illustrate to illustrate a particular embodiment of a multi spiral inductor that includes spirals having turn spacing varying at different rates;

FIG. 5 is a diagram to illustrate examples of shapes of spiral inductors that can be used in the multi spiral inductors of FIGS. 1-4;

FIG. 6 is a flowchart to illustrate a particular embodiment of a method of forming a multi spiral inductor;

FIG. 7 is a block diagram of a wireless device including a multi spiral inductor; and

FIG. 8 is a data flow diagram of a particular illustrative embodiment of a manufacturing process to manufacture electronic devices that include a multi spiral inductor.

### V. DETAILED DESCRIPTION

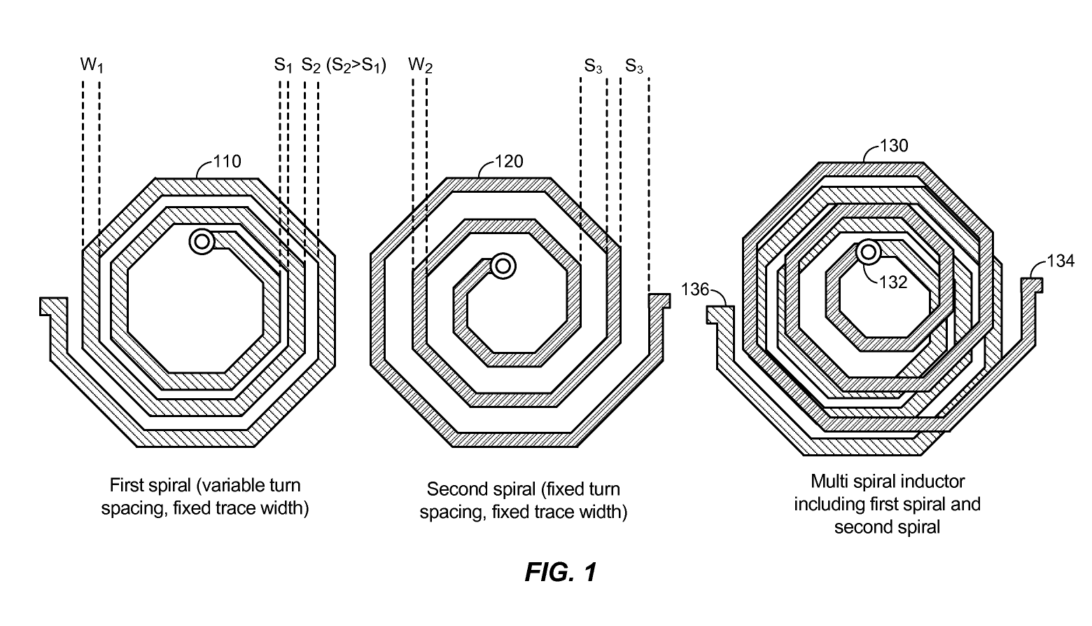

Referring to FIG. 1, a particular illustrative embodiment of a multi spiral inductor 130 is shown. The multi spiral inductor 130 includes a first spiral (e.g., a first planar spiral inductor) 110 and a second spiral (e.g., a second planar spiral inductor) 120 in a stacked configuration and connected by a via 132. In an illustrative embodiment, the first spiral 110 is located on a first (e.g., lower) layer of a multilayer device, the second spiral 120 is located on a second (e.g., higher) layer of the multilayer device, and the via 132 is an interlayer via.

The first spiral 110 may include a plurality of turns. As used herein, a “turn” of a spiral may be a portion of the spiral that is 360 degrees or less. A complete turn may be 360 degrees. Thus, in the example of FIG. 1, the first spiral 110 includes 2.75 turns. In alternate embodiments, the first spiral 110 includes more turns or fewer turns. The first spiral 110 may have various design parameters, such as turn angle, radius, trace width, and number of turns. In the example of FIG. 1, the first spiral 110 has a fixed trace width W₁ (e.g., each segment of the spiral inductor is of equal width). The first spiral 110 has variable turn spacing. For example, a first turn and a second turn of the first spiral 110 are separated by first turn spacing S₁. The second turn and a third turn of the first spiral 110 are separated by second turn spacing S₂. The first turn may be closer from a center of the first spiral 110 than the second turn, the second turn may be closer from a center of the first spiral 110 than the third turn, and the first turn spacing S₁ may be smaller than the second turn spacing S₂, as shown.

Using variable turn spacing instead of fixed turn spacing in the first spiral 110 may improve inductive properties of the first spiral 110. During operation, parallel segments of a spiral inductor may experience parallel coupling, resulting in magnetic loss. Increasing turn spacing may result in improved performance due to decreased parallel coupling. For example, a Q factor of the first spiral 110 may be increased as compared to a spiral that has fixed spacing. Longer parallel segments of a spiral inductor may experience more magnetic loss than shorter parallel segments. Thus, outer turns of a spiral inductor may experience more magnetic loss than inner turns due to parallel coupling. To counteract the increased parallel coupling between outer turns, the turn spacing may be larger for outer turns relative to inner turns. To illustrate, in FIG. 1, the turn spacing S₂ is larger than the turn spacing S₁. If the first spiral 110 had another turn, a third (outermost) turn spacing S₃ may be larger than S₂. In a particular embodiment, successive turn spacings vary linearly, exponentially, or by some other factor.

The multi spiral inductor 130 includes the first spiral 110 and the second spiral 120 connected by the via 132. The first spiral 110 and the second spiral 120 may be asymmetrical (e.g., have different center axes), as shown in FIG. 1, or may be symmetrical (e.g., have the same center axis). In the example of FIG. 1, the second spiral 120 has a fixed trace width W₂ and a fixed turn spacing S₃. W₂ may be the same as or different from W₁, and S₃ may be different from S₁ and/or S₂. In alternate embodiments, the second spiral 120 may have variable turn spacing, which may or may not vary at a different rate than the variable turn spacing of the first spiral 110. Alternatively, or in addition, the second spiral 120 may have a variable trace width.

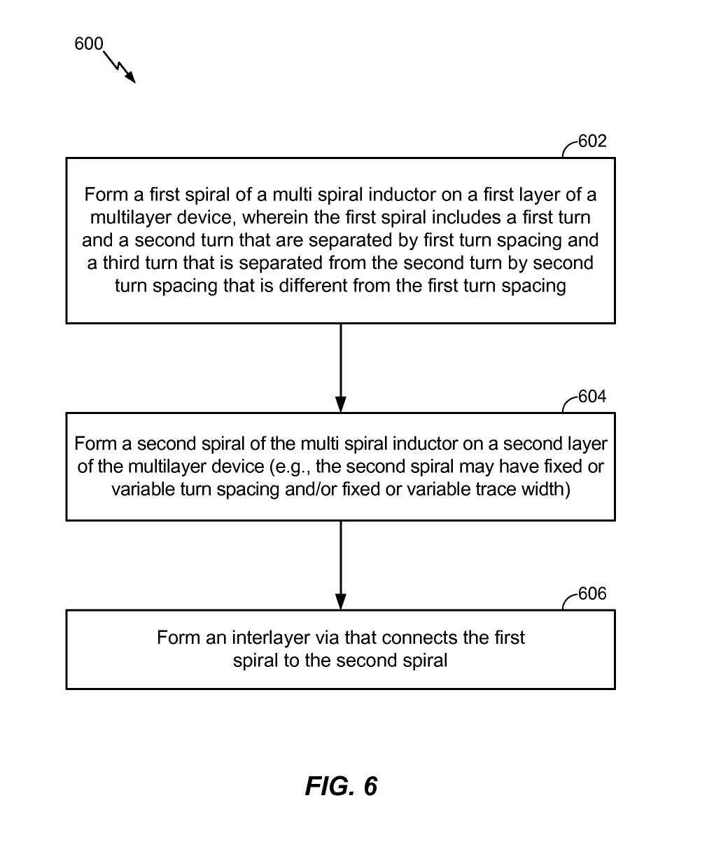

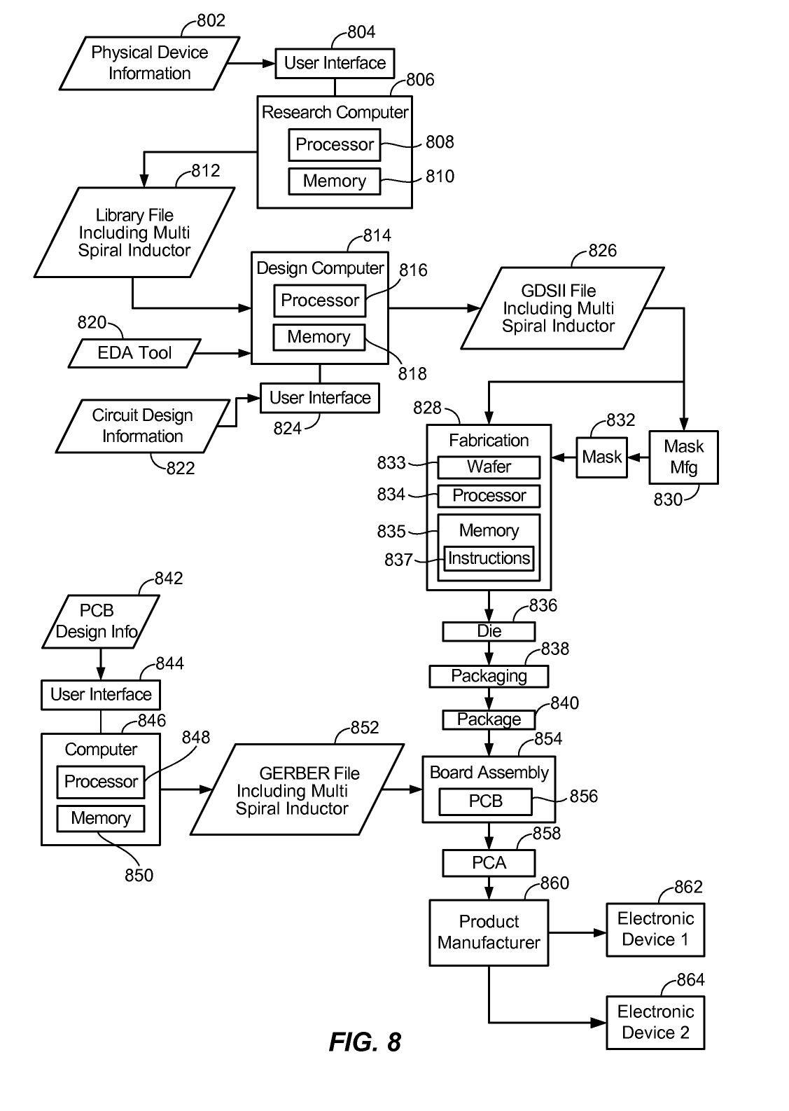

In a particular embodiment, the multi spiral inductor 130 is formed during fabrication of an electronic device (e.g., a printed circuit board, a semiconductor device, etc.). Alternately, the multi spiral inductor 130 may be pre-fabricated and included in an electronic device. As further described with reference to FIG. 6 and FIG. 8, forming the multi spiral inductor 130 may include forming the first spiral 110, the second spiral 120, and the via 132. The multi spiral inductor 130 may be connected to other components (e.g., circuit components, such as resistors, capacitors, transistors, other inductors, etc.) via leads 134 and 136.

The multi spiral inductor 130 may thus exhibit improved performance (e.g., higher Q factor) as compared to a multi spiral inductor in which turn spacing is constant, due to decreased parallel coupling between turns of the spirals of the multi spiral inductor 130. Because the multi spiral inductor 130 has an increased Q factor, the multi spiral inductor 130 may achieve a desired inductance while maintaining a smaller size than multi spiral inductors that have lower Q factors. Thus, for a particular Q factor, the described techniques may enable use of a smaller (e.g., less chip area and/or volume) multi spiral inductor, and for a particular area/volume multi spiral inductor, the described techniques may provide higher Q factor. It will therefore be appreciated that the multi spiral inductor 130 of FIG. 1 may enable design of smaller circuits/chipsets/packages with higher inductor Q factor.

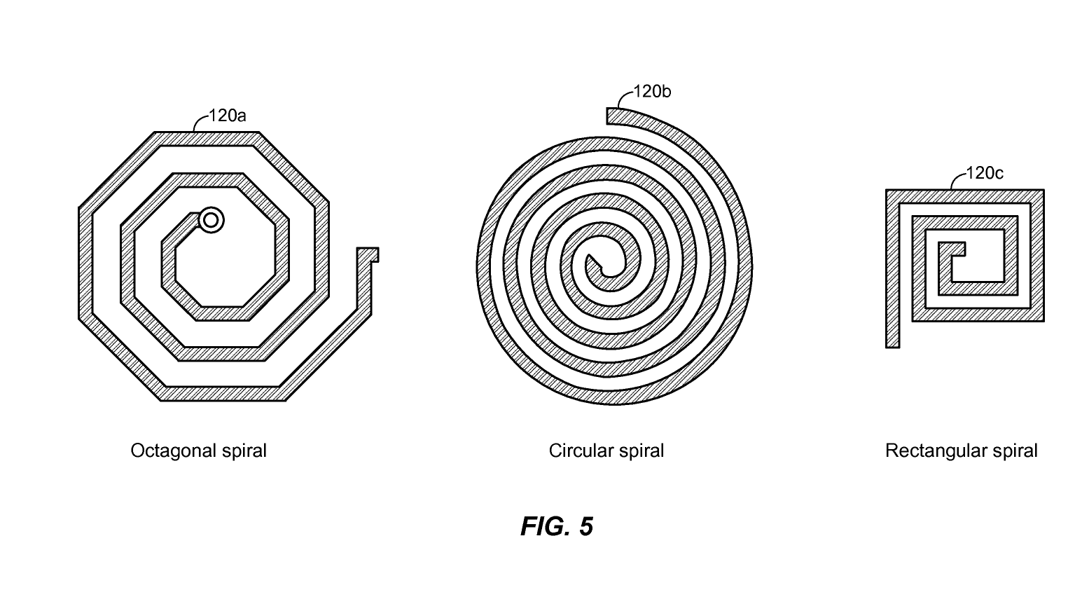

It should be noted that although the spirals 110 and 120 are illustrated in FIG. 1 as octagonal spiral inductors, this is for illustration only, and not to be considered limiting. In alternate embodiments, spiral inductors may be circular, rectangular, or some other shape. For example, as shown in FIG. 5, the second spiral inductor 120 may be octagonal (as shown at 120a), circular (as shown at 120b), rectangular (as shown at 120c), or some other shape. Although various embodiments of multi spiral inductors are described herein as having two spirals, this is also for illustration only, and not to be considered limiting. In alternate embodiments, a multi spiral inductor may include more than two spirals. Spirals of a multi spiral inductor may vary from each other with respect to length (e.g., number of turns). In a particular embodiment, a multi spiral (e.g., double spiral) inductor may be preferable to a single spiral inductor because the multi spiral inductor may provide increased inductance density (and therefore increased Q factor) in the same area (e.g., chip area).

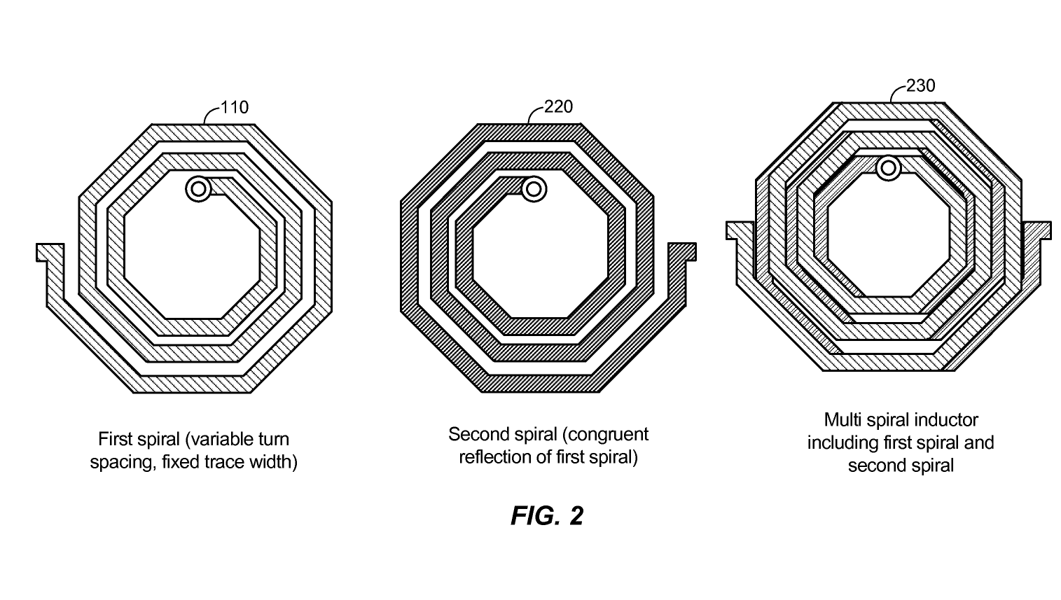

Referring to FIG. 2, another particular illustrative embodiment of a multi spiral inductor 230 is shown. The multi spiral inductor 230 includes the first spiral 110 of FIG. 1, which has variable turn spacing and fixed trace width. The multi spiral inductor 230 also includes a second spiral 220. The second spiral 220 is a congruent reflection of the first spiral 110. Thus, the second spiral 220 has the same turn spacing and trace width as the first spiral 110, but the turns of the second spiral 220 are counterclockwise whereas the turns of the first spiral 110 are clockwise. In a particular embodiment, the multi spiral inductor 230 has a higher Q factor than the multi spiral inductor 130 of FIG. 1, because both spirals of the multi spiral inductor 230 experience reduced parallel coupling due to variable (e.g., increasing) turn spacing.

FIGS. 1-2 thus illustrate multi spiral inductors that exhibit increased Q factor due to variable turn spacing. It should be noted that Q factor may also be improved by using variable trace width instead of, or in addition to, variable turn spacing. To, illustrate, consider the second spiral 120 of FIG. 1, which includes 2.75 turns. The second spiral 120 can be modeled as a set of concentric circular inductors. Each circular inductor (e.g., each turn) contributes a magnetic field to a center/core of the spiral 120. Due to high conductivity, inner turns may cause magnetic loss in higher turns. For example, the innermost first turn may cause magnetic loss in the outer 1.75 turns, the inner 2 turns may cause magnetic loss in the outer 0.75 turns, etc. To counter this nesting/compounding magnetic loss, the trace width of outer turns may be increased, which may increase Q factor. The positive impact on Q factor of reducing the magnetic loss caused by inner turns may be larger than the negative impact of making the inner turns narrower (and therefore higher-resistance).

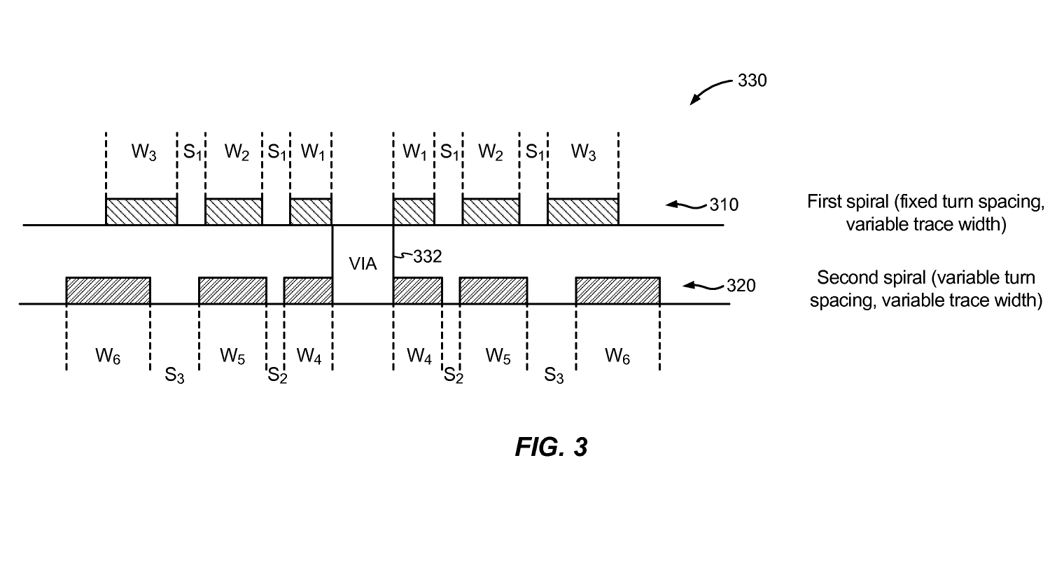

FIG. 3 depicts a cross-section view of a particular illustrative embodiment of a multi spiral inductor 330 that has variable trace width. The multi spiral inductor 330 includes a first spiral 310 and a second spiral 320 connected by a via 332. The first spiral 310 has a fixed turn spacing (S₁) and variable trace width (W₁, W₂, and W₃). The second spiral 320 has variable turn spacing (S₂ and S₃) and variable trace width (W₄, W₅, and W₆).

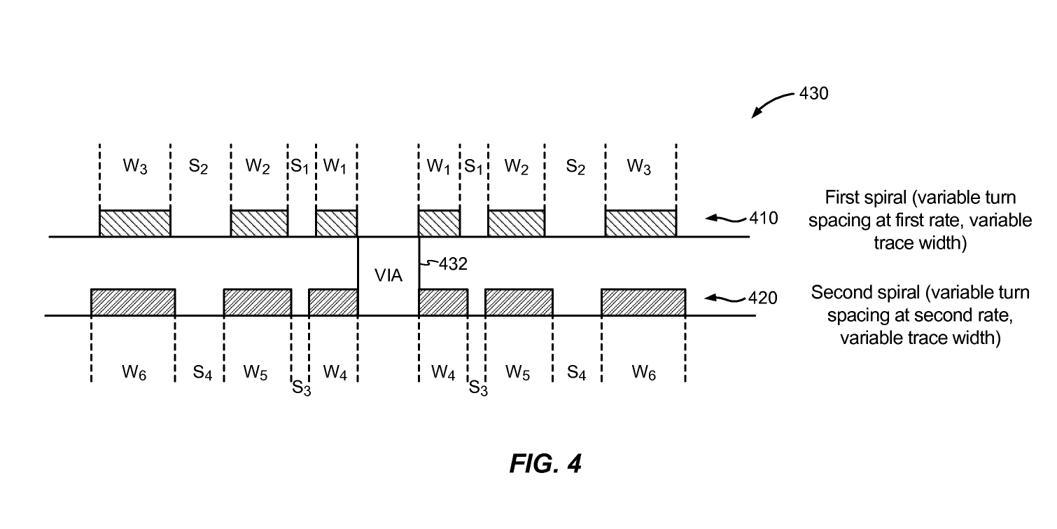

FIG. 4 depicts a cross-section view of another particular illustrative embodiment of a multi spiral inductor 430. The multi spiral inductor 430 includes a first spiral 410 and a second spiral 420 connected by a via 432. The first spiral 410 has variable turn spacing (S₁ and S₂) and variable trace width (W₁, W₂, and W₃). The turn spacing of the first spiral 410 varies at a first rate R₁ (e.g., S₂/S₁=R₁ or S₂−S₁=R₁). The second spiral 420 has variable turn spacing (S₃ and S₄) and variable trace width (W₄, W₅, and W₆). The turn spacing of the second spiral 420 varies at a second rate R₂ (e.g., S₄/S₃=R₂ or S₄−S₃=R₁), where the second rate R₂ is different from the first rate R₁.

In a particular embodiment, trace width and/or turn spacing may vary incrementally within a turn of a spiral in a multi spiral inductor. For example, in FIG. 1, the first spiral 120 is an octagonal spiral and each turn of the first spiral 120 includes eight sides. Each side may contribute an incremental portion of the turn spacing changes, and a sum of the incremental turn spacing change of each of the eight sides may be equal to the total turn spacing difference associated with the turn. As another example, although a circular spiral (e.g., the circular spiral 120b of FIG. 5) does not have any “sides,” trace width and/or turn spacing may vary uniformly or non-uniformly within a turn of the circular spiral.

FIG. 6 is a flowchart to illustrate a particular embodiment of a method 600 of forming a multi spiral inductor. In an illustrative embodiment, the method 600 may be performed by a manufacturing or fabrication system (e.g., as further described with reference to FIG. 8) to form a multi spiral inductor, such as the multi spiral inductor 130, 230, 330, and/or 430.

The method 600 may include forming a first spiral of a multi spiral inductor on a first layer of a multilayer device, at 602. The first spiral may include a first turn and a second turn that are separated by first turn spacing. The first spiral may also include a third turn that is separated from the second turn by second turn spacing that is different from the first turn spacing. For example, in FIG. 1, the first spiral 110 may be formed, where the first spiral 110 has the turn spacings S₁ and S₂.

The method 600 may also include forming a second spiral of the multi spiral inductor on a second layer of the multilayer device, at 604. The second spiral may have fixed turn spacing (e.g., the turn spacing S₃ of FIG. 1) or variable turn spacing (e.g., the turn spacings S₂ and S₃ of FIG. 3). Alternately, or in addition, the second spiral may have fixed trace width (e.g., the trace width W₂ of FIG. 1) or variable trace width (e.g., the trace widths W₄, W₅, and W₆ of FIG. 3).

The method 600 may further include forming an interlayer via that connects the first spiral to the second spiral, at 606. For example, referring to FIG. 1, the via 132 may be formed.

In a particular embodiment, the first spiral, the second spiral, and the via may be formed using a complementary metal oxide semiconductor (CMOS) process, a photo resist process, a chemical vapor deposition process, a glass-based process, a wet etching process, a dry etching process, a lithography process, a planarization process, etc. In one example, the process may use a substrate formed of an insulator, glass, an alkaline earth boro-aluminosilicate glass, Silicon (Si), Gallium Arsenide (GaAs), Indium Phosphate (InP), Silicon Carbide (SiC), a glass-based laminate, sapphire (Al₂O₃), quartz, a ceramic, Silicon on Insulator (SOI), Silicon on Sapphire (SOS), high resistivity Silicon (HRS), Aluminum Nitride (AlN), a plastic, or a combination thereof. The spirals may be formed by depositing a material on top of the substrate. For example, the material may include aluminum, copper, silver, gold, tungsten, molybdenum, an alloy of aluminum, silver, gold, tungsten, or molybdenum, or a combination thereof. The via may be formed by depositing a conductive material, depositing a mask, and performing an etching process.

It should be noted that the order of steps shown in FIG. 6 is for example only. In alternate embodiments, steps may be combined and/or performed in a different order. For example, the via may be formed after the first spiral but before the second spiral. The method 600 of FIG. 6 may be initiated by a processing unit such as a central processing unit (CPU), a field-programmable gate array (FPGA) device, an application-specific integrated circuit (ASIC), a controller, another hardware device, firmware device, or any combination thereof. As an example, the method 600 of FIG. 6 can be initiated by fabrication equipment, such as a processor within or coupled to fabrication equipment and that executes instructions stored at a memory (e.g., a non-transitory computer-readable medium), as described further with reference to FIG. 8. Integrated circuit manufacturing processes, such as wet etching, dry etching, deposition, planarization, lithography, or a combination thereof, may be used to fabricate multi spiral inductors described herein. Alternatively, a multi spiral inductor as described herein may be formed and/or used in devices other than integrated circuit based devices.

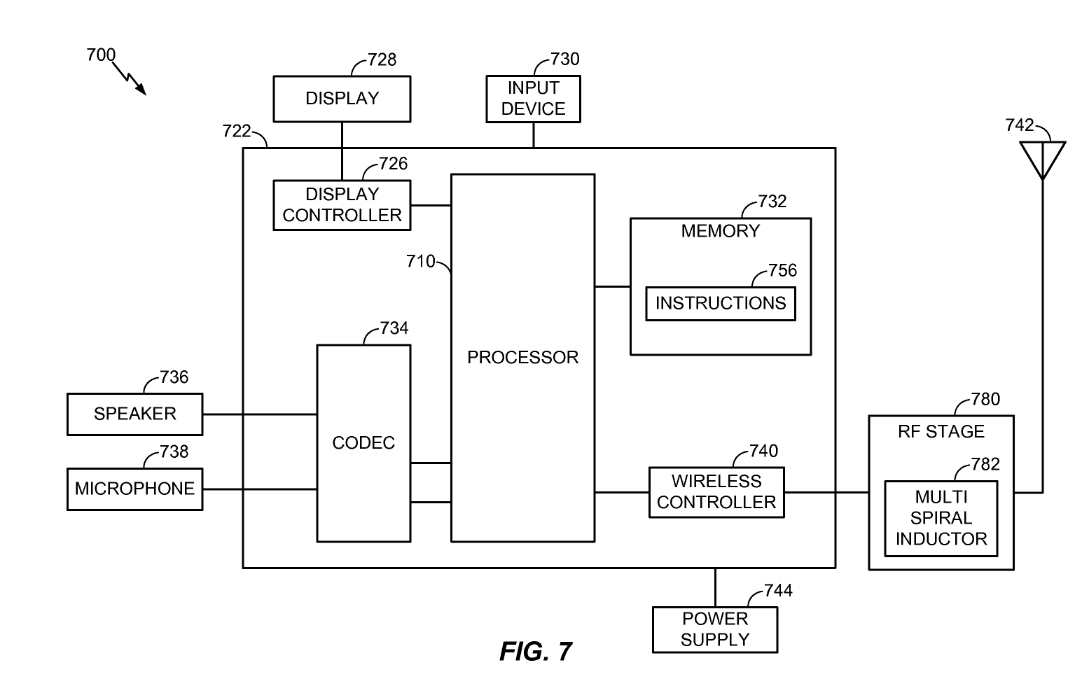

Referring to FIG. 7, a block diagram of a wireless device 700 including a multi spiral inductor is shown. The wireless device 700 includes a processor 710, such as a digital signal processor (DSP) or a central processing unit (CPU), coupled to a memory 732. FIG. 7 also shows a display controller 726 that is coupled to the processor 710 and to a display 728. A coder/decoder (CODEC) 734 can also be coupled to the processor 710. A speaker 736 and a microphone 738 can be coupled to the CODEC 734.

FIG. 7 further indicates that a wireless controller 740 can be coupled to the processor 710 and to an antenna 742 via a radio-frequency (RF) stage 780 disposed between the wireless controller 740 and the antenna 742. In a particular embodiment, the RF stage 780 includes a multi spiral inductor 782. For example, the multi spiral inductor 782 may be the multi spiral inductor 130, 230, 330, or 430, and may be formed according to the method 600 of FIG. 6. In a particular embodiment, the multi spiral inductor is included in an inductor (L) capacitor (C) voltage controlled oscillator (LC-VCO), an LC-based filter, a matching circuit, or another component of the RF stage 780.

The memory 732 may be a tangible non-transitory processor-readable storage medium that includes executable instructions 756. The instructions 756 may be executed by a processor, such as the processor 710, to perform or initiate performance of one or more of operations, functions, and/or methods. In a particular embodiment, the processor 710, the display controller 726, the memory 732, the CODEC 734, and the wireless controller 740 are included in a system-in-package or system-on-chip device 722. In a particular embodiment, an input device 730 and a power supply 744 are coupled to the system-on-chip device 722. Moreover, in a particular embodiment, as illustrated in FIG. 7, the display 728, the input device 730, the speaker 736, the microphone 738, the antenna 742, and the power supply 744 are external to the system-on-chip device 722. However, each of the display 728, the input device 730, the speaker 736, the microphone 738, the antenna 742, and the power supply 744 can be coupled to a component of the system-on-chip device 722, such as an interface or a controller.

In conjunction with the described embodiments, an apparatus includes a multi spiral inductor that includes first means for storing energy in a magnetic field. The first means for storing includes a first turn, a second turn, and a third turn. The first turn is adjacent to and separated from the second turn by first spacing, and the second turn is adjacent to and separated from the third turn by second spacing. The first spacing is different from the second spacing or a first trace width of the first turn is different from a second trace width of the second turn. For example, the first means for storing energy in a magnetic field may include a spiral inductor having variable turn spacing and/or variable trace width, such as the spiral 110 of FIGS. 1-2, the spiral 220 of FIG. 2, the spiral 310 of FIG. 3, the spiral 320 of FIG. 3, the spiral 410 of FIG. 4, the spiral 420 of FIG. 4, one or more other devices or circuits configured to store energy in a magnetic field and having variable turn spacing, or any combination thereof.

The multi spiral inductor also includes second means for storing energy in a magnetic field. For example, the second means for storing energy in a magnetic field may include a spiral inductor, such as the spiral 110, the spiral 120, the spiral 120a, the spiral 120b, the spiral 120c, the spiral 220, the spiral 310, the spiral 320, the spiral 410, the spiral 420, one or more other devices or circuits configured to store energy in a magnetic field, or any combination thereof.

The multi spiral inductor further includes means for connecting the first means for storing and the second means for storing. For example, the means for connecting may include the via 132, the via 332, the via 432, one or more other devices or circuits configured to connect inductors, or any combination thereof.

The foregoing disclosed devices and functionalities may be designed and configured into computer files (e.g. RTL, GDSII, GERBER, etc.) stored on computer-readable media. Some or all such files may be provided to fabrication handlers to fabricate devices based on such files. Resulting products include wafers that are then cut into dies and packaged into chips. The chips are then employed in devices including, but not limited to, a mobile phone, a communications device, a set top box, a music player, a video player, an entertainment unit, a navigation device, a personal digital assistant (PDA), a fixed location data unit, or a computer. FIG. 8 depicts a particular illustrative embodiment of an electronic device manufacturing process 800.

Physical device information 802 is received at the manufacturing process 800, such as at a research computer 806. The physical device information 802 may include design information representing at least one physical property of an electronic device, such as a multi spiral inductor (e.g., corresponding to the multi spiral inductor 130, 230, 330, or 430). For example, the physical device information 802 may include physical parameters, material characteristics, and structure information that is entered via a user interface 804 coupled to the research computer 806 ((e.g., turn spacing, trace width, etc. of the multi spiral inductor may be entered into the research computer 806). The research computer 806 includes a processor 808, such as one or more processing cores, coupled to a computer-readable medium such as a memory 810. The memory 810 may store computer-readable instructions that are executable to cause the processor 808 to transform the physical device information 802 to comply with a file format and to generate a library file 812.

In a particular embodiment, the library file 812 includes at least one data file including the transformed design information. For example, the library file 812 may include a library of electronic devices (e.g., semiconductor devices), including a multi spiral inductor (e.g., corresponding to the multi spiral inductor 130, 230, 330, or 430), provided for use with an electronic design automation (EDA) tool 820.

The library file 812 may be used in conjunction with the EDA tool 820 at a design computer 814 including a processor 816, such as one or more processing cores, coupled to a memory 818. The EDA tool 820 may be stored as processor executable instructions at the memory 818 to enable a user of the design computer 814 to design a circuit including a multi spiral inductor (e.g., corresponding to the multi spiral inductor 130, 230, 330, or 430), using the library file 812. For example, a user of the design computer 814 may enter circuit design information 822 via a user interface 824 coupled to the design computer 814. The circuit design information 822 may include design information representing at least one physical property of an electronic device, such as a multi spiral inductor (e.g., corresponding to the multi spiral inductor 130, 230, 330, or 430). To illustrate, the circuit design property may include identification of particular circuits and relationships to other elements in a circuit design, positioning information, feature size information, interconnection information, or other information representing a physical property of an electronic device.

The design computer 814 may be configured to transform the design information, including the circuit design information 822, to comply with a file format. To illustrate, the file formation may include a database binary file format representing planar geometric shapes, text labels, and other information about a circuit layout in a hierarchical format, such as a Graphic Data System (GDSII) file format. The design computer 814 may be configured to generate a data file including the transformed design information, such as a GDSII file 826 that includes information describing a multi spiral inductor (e.g., corresponding to the multi spiral inductor 130, 230, 330, or 430), in addition to other circuits or information. To illustrate, the data file may include information corresponding to a system-on-chip (SOC) or a chip interposer component that that includes a multi spiral inductor (e.g., corresponding to the multi spiral inductor 130, 230, 330, or 430), and that also includes additional electronic circuits and components within the SOC.

The GDSII file 826 may be received at a fabrication process 828 to manufacture a multi spiral inductor (e.g., corresponding to the multi spiral inductor 130, 230, 330, or 430) according to transformed information in the GDSII file 826. For example, a device manufacture process may include providing the GDSII file 826 to a mask manufacturer 830 to create one or more masks, such as masks to be used with photolithography processing, illustrated in FIG. 8 as a representative mask 832. The mask 832 may be used during the fabrication process to generate one or more wafers 833, which may be tested and separated into dies, such as a representative die 836. The die 836 includes a circuit including a multi spiral inductor (e.g., corresponding to the multi spiral inductor 130, 230, 330, or 430).

In a particular embodiment, the fabrication process 828 may be initiated by or controlled by a processor 834. The processor 834 may access a memory 835 that includes executable instructions such as computer-readable instructions or processor-readable instructions. The executable instructions may include one or more instructions that are executable by a computer, such as the processor 834.

The fabrication process 828 may be implemented by a fabrication system that is fully automated or partially automated. For example, the fabrication process 828 may be automated and may perform processing steps according to a schedule. The fabrication system may include fabrication equipment (e.g., processing tools) to perform one or more operations to form an electronic device. For example, the fabrication equipment may be configured to form one or more spirals, to form one or more passivation layers, to form one or more vias, to perform one or more etches, to form one or more metal structures, or to form other integrated circuit elements using integrated circuit manufacturing processes (e.g., wet etching, dry etching, deposition, planarization, lithography, or a combination thereof).

The fabrication system may have a distributed architecture (e.g., a hierarchy). For example, the fabrication system may include one or more processors, such as the processor 834, one or more memories, such as the memory 835, and/or controllers that are distributed according to the distributed architecture. The distributed architecture may include a high-level processor that controls or initiates operations of one or more low-level systems. For example, a high-level portion of the fabrication process 828 may include one or more processors, such as the processor 834, and the low-level systems may each include or may be controlled by one or more corresponding controllers. A particular controller of a particular low-level system may receive one or more instructions (e.g., commands) from a high-level system, may issue sub-commands to subordinate modules or process tools, and may communicate status data back to the high-level system. Each of the one or more low-level systems may be associated with one or more corresponding pieces of fabrication equipment (e.g., processing tools). In a particular embodiment, the fabrication system may include multiple processors that are distributed in the fabrication system. For example, a controller of a low-level system component of the fabrication system may include a processor, such as the processor 834.

Alternatively, the processor 834 may be a part of a high-level system, subsystem, or component of the fabrication system. In another embodiment, the processor 834 includes distributed processing at various levels and components of a fabrication system.

Thus, the memory 835 may include processor-executable instructions 837 that, when executed by the processor 834, cause the processor 834 to initiate or control formation of a multi spiral inductor that includes a first spiral on a first layer, a second spiral on a second layer, and an interlayer via that connects the first spiral and the second spiral. For example, various layers may be formed by one or more deposition tools, such as a flowable chemical vapor deposition (FCVD) tool or a spin-on deposition tool. Structures, such as spirals and vias, may be etched from a layer by one or more etching machines or etchers, such as a wet etcher, a dry etcher, or a plasma etcher.

As an illustrative example, the processor 834 may control steps for forming a first spiral of a multi spiral inductor on a first layer of a multilayer device, forming a second spiral of the multi spiral inductor on a second layer of the multilayer device, and forming an interlayer via that connects the first spiral to the second spiral. For example, the processor 834 may be embedded in or coupled to one or more controllers that control one or more pieces of fabrication equipment to perform the steps. The processor 834 may control the steps by executing the instructions 837 to control (e.g., activate, deactivate, schedule, etc.) one or more other processes configured to form spirals and vias. To illustrate, a first instruction or set of instructions may be executable to cause the processor 834 to activate a process and associated machinery that operates to form a first spiral on a first layer of a multilayer device. A second instruction or set of instructions may be executable to cause the processor 834 to activate a process and associated machinery that operates to form a second spiral on a second layer of the multilayer device. A third instruction or set of instructions may be executable to cause the processor 834 to activate a process and associated machinery that operates to form an interlayer via that connects the first spiral to the second spiral. In a particular embodiment, integrated circuit manufacturing processes (e.g., wet etching, dry etching, deposition, planarization, lithography, or a combination thereof) may be used to fabricate the spirals and vias.

The die 836 may be provided to a packaging process 838 where the die 836 is incorporated into a representative package 840. For example, the package 840 may include the single die 836 or multiple dies, such as a system-in-package (SiP) arrangement. The package 840 may be configured to conform to one or more standards or specifications, such as Joint Electron Device Engineering Council (JEDEC) standards.

Information regarding the package 840 may be distributed to various product designers, such as by use of a component library stored at a computer 846. The computer 846 may include a processor 848, such as one or more processing cores, coupled to a memory 850. A printed circuit board (PCB) tool may be stored as processor executable instructions at the memory 850 to process PCB design information 842 received from a user of the computer 846 via a user interface 844. The PCB design information 842 may include physical positioning information of a packaged electronic device on a circuit board, the packaged electronic device corresponding to the package 840 including a multi spiral inductor (e.g., corresponding to the multi spiral inductor 130, 230, 330, or 430).

The computer 846 may be configured to transform the PCB design information 842 to generate a data file, such as a GERBER file 852 with data that includes physical positioning information of a packaged electronic device on a circuit board, as well as layout of electrical connections such as traces and vias, where the packaged electronic device corresponds to the package 840 including a multi spiral inductor (e.g., corresponding to the multi spiral inductor 130, 230, 330, or 430). In other embodiments, the data file generated by the transformed PCB design information may have a format other than a GERBER format.

The GERBER file 852 may be received at a board assembly process 854 and used to create PCBs, such as a representative PCB 856, manufactured in accordance with the design information stored within the GERBER file 852. For example, the GERBER file 852 may be uploaded to one or more machines to perform various steps of a PCB production process. The PCB 856 may be populated with electronic components including the package 840 to form a representative printed circuit assembly (PCA) 858.

The PCA 858 may be received at a product manufacturer 860 and integrated into one or more electronic devices, such as a first representative electronic device 862 and a second representative electronic device 864. As an illustrative, non-limiting example, the first representative electronic device 862, the second representative electronic device 864, or both, may be selected from a set top box, a music player, a video player, an entertainment unit, a navigation device, a communications device, a personal digital assistant (PDA), a fixed location data unit, and a computer, into which a multi spiral inductor (e.g., corresponding to the multi spiral inductor 130, 230, 330, or 430), is integrated. As another illustrative, non-limiting example, one or more of the electronic devices 862 and 864 may be remote units such as mobile phones, hand-held personal communication systems (PCS) units, portable data units such as personal data assistants, global positioning system (GPS) enabled devices, navigation devices, fixed location data units such as meter reading equipment, or any other device that stores or retrieves data or computer instructions, or any combination thereof. Although FIG. 8 illustrates remote units according to teachings of the disclosure, the disclosure is not limited to these illustrated units. Embodiments of the disclosure may be suitably employed in any device which includes active integrated circuitry including an inductor. Embodiments of the disclosure may also be employed in non-integrated circuit based devices that include an inductor.

A device that includes a multi spiral inductor (e.g., corresponding to the multi spiral inductor 130, 230, 330, or 430) may be fabricated, processed, and incorporated into an electronic device, as described in the illustrative manufacturing process 800. One or more aspects of the embodiments disclosed with respect to FIGS. 1-7 may be included at various processing stages, such as within the library file 812, the GDSII file 826, and the GERBER file 852, as well as stored at the memory 810 of the research computer 806, the memory 818 of the design computer 814, the memory 850 of the computer 846, the memory of one or more other computers or processors (not shown) used at the various stages, such as at the board assembly process 854, and also incorporated into one or more other physical embodiments such as the mask 832, the die 836, the package 840, the PCA 858, other products such as prototype circuits or devices (not shown), or any combination thereof. Although various representative stages are depicted with reference to FIGS. 1-7, in other embodiments fewer stages may be used or additional stages may be included. Similarly, the process 800 of FIG. 8 may be performed by a single entity or by one or more entities performing various stages of the manufacturing process 800.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
a multi spiral inductor that includes a first spiral and a second spiral,
wherein the first spiral includes a first turn, a second turn, and a third turn,
wherein the first turn is adjacent to and separated from the second turn by first spacing,
wherein the second turn is adjacent to and separated from the third turn by second spacing, and
wherein the first spacing is different from the second spacing.

2. The apparatus of claim 1, wherein the first turn is closer from a center of the spiral inductor than the second turn, wherein the second turn is closer from the center of the spiral inductor than the third turn, and wherein the first spacing is smaller than the second spacing.

3. The apparatus of claim 1, wherein the first spiral is located on a first layer of a multilayer device, wherein the second spiral is located on a second layer of the multilayer device, and wherein the first spiral and the second spiral are connected by an interlayer via.

4. The apparatus of claim 1, wherein the second spiral has fixed turn spacing.

5. The apparatus of claim 1, wherein the second spiral has fixed trace width.

6. The apparatus of claim 1, wherein the second spiral has variable turn spacing that differs from turn spacing of the first spiral.

7. The apparatus of claim 1, wherein the second spiral has variable trace width.

8. The apparatus of claim 1, wherein the first spiral has variable trace width.

9. The apparatus of claim 1, wherein the first spiral comprises an octagonal spiral.

10. The apparatus of claim 1, wherein the first spiral comprises a circular spiral.

11. The apparatus of claim 1, wherein the first spiral comprises a rectangular spiral.

12. The apparatus of claim 1, wherein the first spiral and the second spiral are congruent reflections of each other.

13. The apparatus of claim 1, wherein the multi spiral inductor is integrated into at least one semiconductor die.

14. The apparatus of claim 1, further comprising a device selected from the group consisting of a mobile phone, a set top box, a music player, a video player, an entertainment unit, a navigation device, a communications device, a personal digital assistant (PDA), a fixed location data unit, and a computer, into which the multi spiral inductor is integrated.

15. A method comprising:
forming a first spiral of a multi spiral inductor, wherein the first spiral includes a first turn, a second turn, and a third turn, wherein the first turn is adjacent to and separated from the second turn by first spacing, wherein the second turn is adjacent to and separated from the third turn by second spacing, and wherein the first spacing is different from the second spacing or a first trace width of the first turn is different from a second trace width of the second turn; and
forming a second spiral of the multi spiral inductor.

16. The method of claim 15, further comprising forming the first spiral on a first layer of a multilayer device and forming the second spiral on a second layer of the multilayer device.

17. The method of claim 16, further comprising forming an interlayer via that connects the first spiral to the second spiral.

18. The method of claim 15, wherein the first turn is closer from a center of the spiral inductor than the second turn and wherein the second turn is closer from the center of the spiral inductor than the third turn.

19. The method of claim 18, wherein the first spacing is smaller than the second spacing.

20. The method of claim 18, wherein the first trace width is smaller than the second trace width.

21. The method of claim 15, wherein the second spiral has fixed turn spacing.

22. The method of claim 15, wherein the second spiral has fixed trace width.

23. The method of claim 15, wherein the second spiral has variable turn spacing that differs from turn spacing of the first spiral.

24. The method of claim 15, wherein the second spiral has variable trace width.

25. The method of claim 15, wherein the first spiral and the second spiral are congruent reflections of each other.

26. An apparatus comprising:
a multi spiral inductor comprising:
first means for storing energy in a magnetic field, wherein the first means for storing includes a first turn, a second turn, and a third turn, wherein the first turn is adjacent to and separated from the second turn by first spacing, wherein the second turn is adjacent to and separated from the third turn by second spacing, and wherein the first spacing is different from the second spacing or a first trace width of the first turn is different from a second trace width of the second turn;
second means for storing energy in a magnetic field; and
means for connecting the first means for storing and the second means for storing.

27. The apparatus of claim 26, further comprising a device selected from the group consisting of a mobile phone, a set top box, a music player, a video player, an entertainment unit, a navigation device, a communications device, a personal digital assistant (PDA), a fixed location data unit, and a computer, into which the first means for storing, the second means for storing, and the means for connecting are integrated.

28. A non-transitory computer-readable medium comprising instructions that, when executed by a processor, cause the processor to:
initiate formation of a multi spiral inductor that includes a first spiral and a second spiral,
wherein the first spiral includes a first turn, a second turn, and a third turn,
wherein the first turn is adjacent to and separated from the second turn by first spacing,
wherein the second turn is adjacent to and separated from the third turn by second spacing, and
wherein the first spacing is different from the second spacing.

29. The non-transitory computer-readable medium of claim 28, wherein the second spiral has variable trace width.

30. The non-transitory computer-readable medium of claim 28, wherein the multi spiral inductor is integrated into a device selected from the group consisting of a mobile phone, a set top box, a music player, a video player, an entertainment unit, a navigation device, a communications device, a personal digital assistant (PDA), a fixed location data unit, and a computer.
